(19) United States
(12) Patent Application Publication
(10) Pub. No.: US 2024/0113600 A1
(43) Pub. Date: Apr. 4, 2024

(54) HIGH AND LOW FREQUENCY AC POWER GENERATORS

(71) Applicant: New York University, New York, NY (US)

(72) Inventor: Francisco De Leon, Bogota, NJ (US)

(73) Assignee: New York University, New York, NY (US)

(21) Appl. No.: 18/481,925

(22) Filed: Oct. 5, 2023

Related U.S. Application Data
(63) Continuation-in-part of application No. 16/785,424, filed on Feb. 7, 2020, now abandoned.
(60) Provisional application No. 62/803,293, filed on Feb. 8, 2019.

(51) Int. Cl. H02K 11/30; H02K 1/22

(52) U.S. Cl. CPC H02K 11/30; H02K 1/22

(57) ABSTRACT

A synchronous generator can include a rotor. A three-phase high frequency alternating current source or a three-phase low frequency alternating current source can be in communication with the rotor.

### CROSS-REFERENCE TO RELATED APPLICATIONS

This application is a continuation-in-part of U.S. patent application Ser. No. 16/785,424, filed Feb. 7, 2020, which claims benefit of priority to U.S. Provisional Application No. 62/803,293 filed Feb. 8, 2019, both of which are incorporated herein by reference in their entireties.

### TECHNICAL FIELD

The present disclosure relates generally to systems and method for power generation, specifically to a generator utilizing low and high frequency AC excitation.

### BACKGROUND

Most power generation in the world is done with synchronous generators running at a frequency of 50 Hz or 60 Hz. While AC and DC technologies have their niches in various industries, the AC/DC battle between Edison/Westinghouse settled in favor of AC, effectively ending DC usage in utility-scale power generation and transmission. For AC systems, utilities experimented with several frequencies from 25 Hz to 133 Hz. With higher frequencies, smaller machinery (generators, transformers, motors) and larger cables are needed. In contrast, lower frequencies require larger machines with smaller cables, but flicker from incandescent bulbs was noticeable. As a compromise between the size of machines and cables together with the need to interconnect, 50 Hz was standardized in Europe. In North America, 60 Hz was selected to reduce flicker that was perceptible with the mercury rectifiers used at the time. Today, with the progress of power electronic switches and convertor configurations, there is a need and capability for more efficient alternatives to use a single frequency.

The new technology can be applied to conventional rotating generation technologies (hydraulic, steam, wind, gas, etc.). The first generator candidates to approach are wind turbines because of their relative lower power output. The reduced size and weight of the new generators will improve the deployment of wind turbines enabling longer blades, increasing their power output. Additionally, it would be possible to generate over a greater range of wind speeds, eliminating the need for complex gear boxes, alignment and supporting equipment. Full generation control can be achieved by simply adjusting the frequency of the exciting current. Existing technology is bulky and makes the installation of off-shore wind turbines complex and expensive.

In the electric power industry, there is a push to generate electricity from renewable resources, wind and solar in particular, to reduce greenhouse emissions. If the generator proposed is successful, the impact to the energy generation market will be significant. This work will reduce the size, cost, and weight of generators, possibly facilitating larger wind-power penetration from off-shore installations. The design of larger output power wind turbines, utilizing smaller generators, reducing hanging weight, which enables increased turbine blade lengths that capture greater amounts of wind, would provide an increase in power output (perhaps to MW levels).

Thus, there is a need for a new technology that would reduce the physical size and weight of generators, providing significant cost reductions as well. The market for such a product would be broad, including any power utility with generator assets.

### SUMMARY

One aspect of the present disclosure is directed to a synchronous generator. The synchronous generator includes a stator, a rotor in communication with the stator, and a three-phase high frequency alternating current source in communication with the rotor.

Another aspect of the present disclosure is directed to a synchronous generator. The synchronous generator includes a rotor, a three-phase high frequency alternating current source in communication with the rotor, an input line in electrical communication with the three-phase high frequency alternating current source, and a stator in communication with the rotor and an output line in communication with an electrical system, the output line being in electrical communication with an input line.

Another aspect of the present disclosure is directed to a synchronous generator. The synchronous generator includes a rotor and a three-phase low frequency alternating current source in communication with the rotor.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1A shows a standard rotor/stator construction; FIG. 1B shows a standard DC excitation construction for a rotor; FIG. 1C shows the measured voltage induced in device of FIG. 1B; FIG. 1D illustrates an embodiment utilizing a DC excitation source; FIG. 1E shows the show the measured voltage induced in device of FIG. 1D; FIG. 1F shows an embodiment with an ideal construction having a three-phase wound rotor that is excited by a three-phase high frequency DC source; and FIG. 1G shows the show the measured voltage induced in device of FIG. 1F.

FIGS. 2A-2D show different generator arrangements and flexible power system connections.

FIG. 3 illustrates a three-phase induction generator in accordance with one embodiment.

FIG. 4 illustrates a computer system for use with certain implementations.

FIG. 5 illustrates a three-phase wound rotor generator excited from a three-phase low-frequency source, according to an example implementation.

FIG. 6 illustrates a three-phase wound rotor generator excited from a set of DC currents, according to an example implementation.

FIG. 7 illustrates an experimental setup, according to an example implementation.

FIGS. 8A and 8B illustrate the voltage captured at the terminals of a three-phase wound rotor machine fed from the rotor windings, according to an example implementation.

FIGS. 9A and 9B illustrate simulated terminal voltages of a three-phase wound rotor machine, according to an example implementation.

FIG. 10 illustrates the output voltage waveforms before the shift at time t and after the shift at t+0.4 s and t+2.5 s, according to an example implementation.

FIG. 11 illustrates the transient from start up to steady state, to excitation shift, to a new steady state 60° ahead, according to an example implementation.

FIG. 12 illustrates an SMIB with synchronous machine test system on EMTP, according to an example implementation.

FIG. 13 illustrates an SMIB test system on PSS/E, according to an example implementation.

FIG. 14 illustrates an EMTP model of the asynchronous machine SMIB with DC rotor excitation, according to an example implementation.

FIG. 15 illustrates a fault cleared at 100 ms comparison between EMTP and PSS/E, according to an example implementation.

FIG. 16 illustrates a fault cleared at 175 ms comparison between EMTP and PSS/E, according to an example implementation.

FIG. 17 illustrates a fault cleared at 180 ms comparison between EMTP and PSS/E, according to an example implementation.

FIG. 18 illustrates the output power of standard DC excitation rotor, constant frequency AC excitation rotor, and variable frequency AC excitation rotor, according to an example implementation.

FIG. 19 illustrates the mechanical angular velocity of standard DC excitation rotor, constant frequency AC excitation rotor, and variable frequency AC excitation rotor, according to an example implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to excitation of the field winding of synchronous generators with high frequency AC or low frequency AC instead of the traditional DC (or permanent magnets). Embodiments further describe a generator that utilizes a high frequency AC source. The excitation method may be extended to utility grade generators of all sizes. By exciting the rotor of a generator with high frequency AC the voltage induction process is more efficient and generators can be made smaller for the same power. In one embodiment further described herein, and wherein a high frequency alternating current source, such as a three-phase AC source, has a frequency in a range of greater than 50 Hz to 6 kHz, for example greater than 50 Hz to 500 Hz.

According to Faraday's Law the voltage induced in the armature of a rotating machine is given by: V=4.44 K Bm f A N, where K is the product of the pitch factor and coil distribution factor, Bm is the design (peak) flux density [T],f is the frequency [Hz] produced by the rotation of the field, A is the cross sectional area [m²], and N is the number of turns. Thus, when applying AC excitation, the voltage induction process is magnified since V is proportional to f. Therefore, for the same induced voltage, the size of a machine, determined by the number of turns N and the cross-sectional area A, can be reduced in proportion to the excitation frequency as:

V=4.44 K Bm (f)↑(A N)↓.

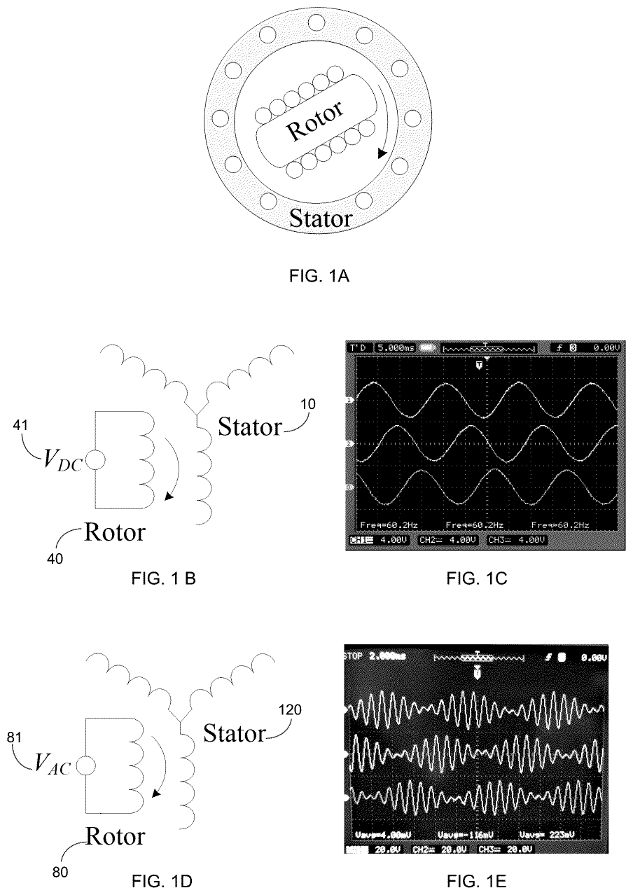

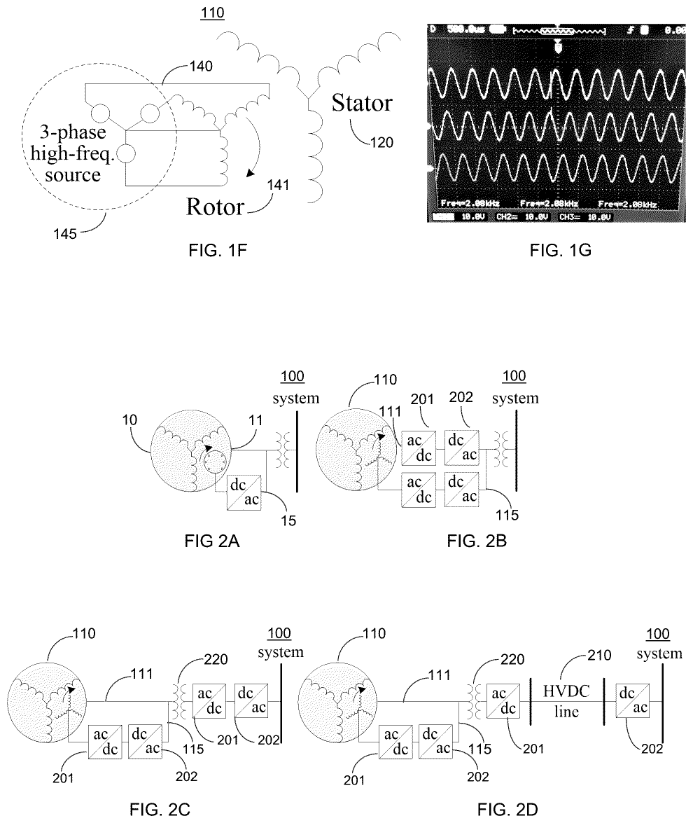

The prior art generators rely upon a DC source for excitation. FIG. 1A illustrates the construction of an example of a salient pole synchronous machine. FIG. 1B is a schematic showing the method most commonly used today to induce a 60 Hz voltage (FIG. 1C) comprising a stator 10 and rotor 40 using a DC excitation 41. The DC current is passed though the excitation winding attached to the rotor 40, which is then revolved on its axis to produce a time varying flux. Voltage is produced in the stator windings (i.e., the armature) and an output is provided in electrical communication with the stator. As an alternative excitation, permanent magnets are used in some gas/wind turbine generators.

In FIG. 1D one embodiment is show where the DC source is replaced with a single-phase high-frequency AC source 81. The use of an AC source 81 produces a modulated magnetic flux (high-frequency results in being over the 60 Hz envelope) as seen in FIG. 1E. One embodiment the rotor 140 is constructed as shown in FIG. 1F where a three-phase rotor winding 141 is energized from a high-frequency three-phase AC source 145. FIGS. 1C, 1E, and 1G represent the measured voltages for each one of the three generator alternatives of FIGS. 1B, 1D, and 1F, respectively, from lab experiments.

Each of FIGS. 1B-1G use 2 kVA machines. FIG. 1B shows that when using a four-pole synchronous generator rotating at a rated speed of 1800 rpm, the traditional DC excitation 41 induces a 60 Hz sinusoidal three-phase voltage (FIG. 1C). Substituting the DC source 41 for a single phase 1,000 Hz AC source 81, as shown in FIG. 1D, the measured terminal voltage of the same generator a modulated 1,000 Hz voltage with a 60 Hz envelope (FIG. 1E). Shown in FIG. 1G is the measured voltage induced in the stator 120 of the generator structure of FIG. 1F, which is a wound rotor 140 excited with a three-phase (2,000 Hz) AC source 145. As expected, the frequency of the voltage is the sum of the excitation frequency (2,000 Hz) and the rotation speed (60 Hz equivalent). This demonstrates that the desired induced high frequency voltage can be obtained from the proposed generator design. Notably, the single-phase excitation, such as in FIGS. 1D-E, will produce a modulating double frequency terminal voltage and flux density. Thus, the maximum design flux density (and size reduction) will be reduced by the lower frequency. The three-phase excitation, such as shown in FIGS. 1F-G, eliminates the modulation.

In one embodiment, the construction of the high frequency AC machine 110 generally has several important differences over currently available wound rotor induction machines. Today standard wound-rotor machines need material suitable for 60 Hz in the stator and a few Hz for the rotor. As such, existing machines typically use iron-core material, for both stator and rotor. The described high frequency AC machine utilizes material suitable for high-frequency operation (greater than 50 Hz to 6 kHz region), such as described further below. The high frequency AC machine, as well as a standard wound-rotor machine, will typically need three slip-rings (one per phase) in comparison to a standard synchronous generator needing two. High frequency can include a frequency greater than 50 Hz. High frequency can include a frequency greater than 60 Hz. For example, high frequency can include 1 kHz.

FIG. 2A shows the connection of a traditional synchronous generator 10 to a system 100. The generator 10 includes an output line 11 and an input line 15 for the electromagnet of the rotor. Often, at the terminals of a large power generator a step-up transformer is connected as shown.

FIGS. 2B-2D illustrate several designs of flexible power systems that can be achieved with a new (high-frequency) generator 110. The generator systems 110 described herein consist generally of a rotor 140 and stator 120, the rotor 140 being in communication with a prime mover, such as the rotational motion generated by a windmill's blades. The rotor 140 is, in some embodiments, a wound rotor, such as with 120° spacings for 3-phase winding and excited by a 3-phase AC source 145. The stator 120 is the stationary component within which the rotor spins to generate the relative motion that drives current. The stator 120 is in communication with an output line 111, which may then be in communication with a series of transformers, convertors or other such devices before reaching the main system 110, which may be, for example, a power grid or an operational device. The rotor 140 includes an input line 115 to provide power to excite the rotor 141, for example the input line 115 may provide AC to the AC source 145. The input line 115 may be in communication with a series of transformers, convertors or other such devices to allow the energy provided to be converted to the high frequency AC for the AC source 145.

Magnetic materials capable of handling high frequency (in the low kHz range) must be used in certain embodiments of the generator to minimize the eddy current and hysteresis losses. Eddy currents are parasitic current induced in conducting materials, which produce losses and heat. All electrical machines must deal with them because ferromagnetic materials (the iron-core of all machines) necessary to magnify the magnetic field are also conductors. Therefore, eddy currents are induced where they are not desired (such as an iron-core). It should be appreciated that the higher the frequency, the more difficult it becomes (because of greater losses) to limit their effect. In 60 Hz machines, manufacturers use laminated steel with 3% silicon. For frequencies in the kilohertz region 6.5% silicon is used. For machines above a few kilohertz only ferrites work.

Embodiments of a high frequency AC machine 110 will include an appropriate material based on the frequency, for example 6.5% silicon-steel. Because of the small size, no special conductors are needed. Larger machines may need continually transposed conductors or Litz wire. The construction of embodiments of the high frequency AC synchronous machine is different from today's synchronous generators. The stator of todays' standard three-phase synchronous machines and induction machines is the same. Embodiments of the high frequency AC synchronous machine 110 may a similar stator. However, there are important differences in the rotor 140 and the operating principle of the high frequency AC synchronous machine is completely different. The high frequency AC synchronous machine 110 has some similarity to an induction machine, but because of the unique excitation (three-phase high-frequency), it operates as a synchronous machine.

FIG. 2B demonstrates the connection of the high-frequency generator 110. In the illustrated embodiment, it is assumed that the generator 110 will be receiving AC power at 60 Hz and that the same is the desired output, however it should be appreciated that these can be different frequencies and the input and output need not be the same. In the illustrated embodiment, the proposed small-size generator 110 may utilize one or more conversion links using AC-to-DC links 201 and DC-to-AC links, for example in one embodiment two DC-links: one to convert the 60 Hz AC input to DC and then to high-frequency AC as the AC source 145 to feed the exciter of the rotor 141 and another one to convert high-frequency AC output from the stator 120 armature to DC and then back to 60 Hz AC to interconnect with the 60 Hz system, or to whatever frequency is appropriate. In some embodiments, the rating of the DC-link of the excitation circuit is much smaller than the armature converters. The AC-to-DC link can include a greater than 50 Hz to 6 kHz AC-to-DC link. The AC-to-DC link can include a greater than 50 Hz to 6 kHz AC link to DC link.

FIG. 2C displays an embodiment having a connection where the high-frequency generator 110 feeds a high-frequency step-up transformer 220 without the need of additional convertors. In this arrangement, the step-up transformer is also much smaller and less expensive than those in existing generation stations.

FIG. 2D reveals another embodiment having a connection for the high-frequency generator. Here the DC-link on the high side of the high-frequency step-up transformer is split with a High Voltage DC (HVDC) transmission line. The arrangement depicted in FIG. 2D allows transmitting the largest amount of power with reduced physical footprint and electrical losses.

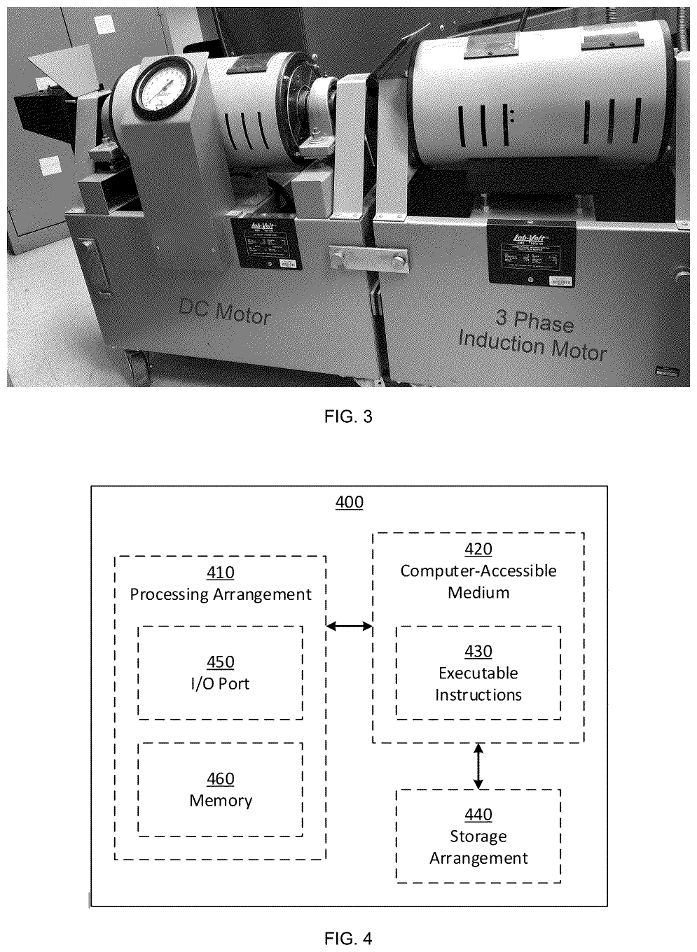

The operating principles of the proposed new generator have been demonstrated using two standard-built (60 Hz, 2 kVA) machines (see FIG. 3): a synchronous generator and a wound rotor three-phase induction machine. The experiments showed the expected high-frequency voltage induced at the machine terminals (see FIGS. 1A-1G).

The synchronous generator can include a stator. The synchronous generator can include a rotor in communication with the stator. For example, the rotor can be coupled with the stator. The rotor can include a silicon-steel alloy. The rotor can include a wound rotor with equidistant three-phase windings.

The synchronous generator can include a three-phase high frequency alternating current source in communication with the rotor. The three-phase high frequency alternating current source can have a frequency in a range of greater than 50 Hz to 6 kHz. For example, the three-phase high frequency alternating current source can have a frequency of greater than 50 Hz. The three-phase high frequency alternating current source can have a frequency of less than or equal to 6 kHz. The three-phase high frequency alternating current source has a frequency in a range of greater than 50 Hz to 500 Hz. For example, the three-phase high frequency alternating current source can have a frequency of less than or equal to 500 Hz.

The synchronous generator can include a three-phase high frequency alternating current source in communication with the rotor. The synchronous generator can include an input line in electrical communication with the three-phase high frequency alternating current source. The synchronous generator can include a stator in communication with the rotor and an output line in communication with an electrical system. The output line can be in electrical communication with the input line.

The three-phase high frequency alternating current source can have a frequency in a range of greater than 50 Hz to 6 kHz. For example, the three-phase high frequency alternating current source can have a frequency of greater than 50 Hz. The three-phase high frequency alternating current source can have a frequency of less than or equal to 6 kHz. The three-phase high frequency alternating current source can have a frequency in a range of greater than 50 Hz to 500 Hz. For example, the three-phase high frequency alternating current source can have a frequency of less than or equal to 500 Hz.

The synchronous generator can include at least one AC-to-DC link and one DC-to-AC link. The synchronous generator can include an AC-to-DC link in communication with a high voltage DC line connected to a DC to AC link.

The output line can include an AC-to-DC link in communication with a high voltage DC line connected to a DC-to-AC link. The input line can include an AC-to-DC link and a DC to a greater than 50 Hz to 6 kHz AC link in communication with the three-phase high frequency alternating current source. The output line can include a greater than 50 Hz to 6 kHz AC link to DC link and an DC to a 60 Hz AC link.

As shown in FIG. 4, for example, a computer-accessible medium 420 (e.g., as described herein, a storage device such as a hard disk, floppy disk, memory stick, CD-ROM, RAM, ROM, etc., or a collection thereof) can be provided (e.g., in communication with the processing arrangement 410). The computer-accessible medium 420 may be a non-transitory computer-accessible medium. The computer-accessible medium 420 can contain executable instructions 430 thereon. Additionally or alternatively, a storage arrangement 440 can be provided separately from the computer-accessible medium 420, which can provide the instructions to the processing arrangement 410 so as to configure the processing arrangement to execute certain exemplary procedures, processes and methods, as described herein, for example. The instructions may include a plurality of sets of instructions. For example, in some implementations, the instructions may include instructions for applying radio frequency energy in a plurality of sequence blocks to a volume, where each of the sequence blocks includes at least a first stage. The instructions may further include instructions for repeating the first stage successively until magnetization at a beginning of each of the sequence blocks is stable, instructions for concatenating a plurality of imaging segments, which correspond to the plurality of sequence blocks, into a single continuous imaging segment, and instructions for encoding at least one relaxation parameter into the single continuous imaging segment.

System 100 may also include a display or output device, an input device such as a keyboard, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

### Enhancement of Transient Stability via a Three-Phase Wound Rotor Synchronous Generator

Power system transient stability can include the ability of generators to continue to operate synchronously after the system is disturbed. Transient stability response can be an important consideration that engineers use when planning and operating power systems. The impending large penetration of low-inertia renewable generation can pose substantial stability challenges. The ongoing power system restructuring can drive power systems to be operated closer to their stability boundaries than ever.

A power system with a large-scale penetration of renewable energy can be weak. Synchronous generators (SG) can provide sufficient inertia to maintain frequency stability because of the synchronization relationship between its heavy rotor and grid frequency. However, the rotor speed of a wind generator can be weakly decoupled from grid frequency. Hence, the inertia response of a wind generator or solar photovoltaic may not even exist. With more penetration of renewables and the necessity of having a solid amount of inertia in the system, there is an imminent need to have stable rotating machinery, especially in form of highly stable synchronous generators.

Few of the techniques used to improve the transient stability performance of synchronous generators have addressed the instability by making structural changes to the synchronous generator. Local wind farms and induction generator-based power plants may be able to improve transient stability of synchronous generators. Local doubly fed induction generator-based (DFIG-based) wind turbines can improve the transient stability of a synchronous generator. This can be performed by a controller that changes the operating mode of DFIG from generator to motor during disturbances, to absorb the excess energy from the SG. This absorbed energy can reduce the acceleration of the SG and therefore improve transient stability. A Wide Area Control (WAC) system can estimate the global energy function of the system and deliver the supplementary damping.

Resistive fault current limiters (RFCL) can enhance transient stability of a power system. An RFCL can include an apparatus that has zero resistance during normal operation of the power system. When a fault happens and fault current passes through RFCL, its resistance can increase, due to intrinsic feature of its superconductive elements, and hence limit the fault current. This reduction in fault current can provide an enhanced ability to maintain synchronization of the system. Rotor damping structure of synchronous generators can impact damping transient oscillations caused by large disturbances. A d-q axis supplementary control scheme can improve the transient behavior of the synchronous generator.

The systems and methods of the present disclosure can include excitation techniques for synchronous generators to substantially enhance their transient stability performance. A three-phase wound rotor excited with a low frequency three-phase current can be used instead of the salient pole or round rotor forming DC poles. The three-phase current can be controlled in a way to fully compensate for the mechanical acceleration that happens during a fault. A machine that is impervious to rotor angle instability is theoretically achievable. The systems and methods can include using wound rotor synchronous generators to enhance the transient stability performance of power systems.

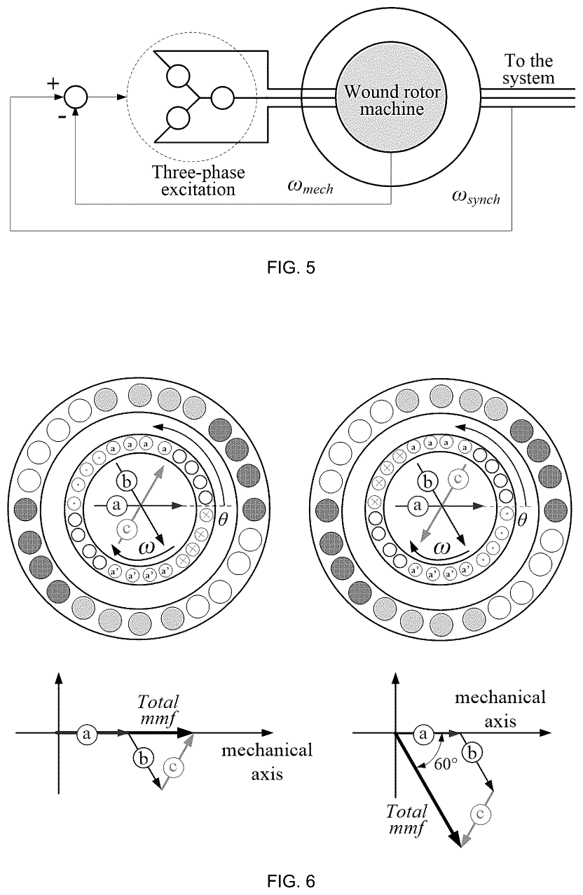

The windings of a three-phase wound rotor synchronous generator can be exited with a low frequency three-phase current (FIG. 5). This can allow controlling the angle of the induced mmf in the stator windings independently from the mechanical angle of the rotor during a transient. FIG. 5 illustrates a three-phase wound rotor generator excited from a three-phase low-frequency source. Mechanical speed can be fed back to close the loop. The frequency can include the rated frequency of the power system.

For DC excitation, the steady state case can be when the wound rotor machine is excited with three equal DC currents with the direction shown in FIG. 6. FIG. 6 illustrates a three-phase wound rotor generator excited from a set of DC currents. The angle difference between the two rotating fields is due to reversing the excitation current of the winding c. FIG. 6 shows two cases with the same mechanical position of the rotor (mechanical axis). The schematic on the left shows the case when the total mmf is in-phase (0°) with the mechanical axis of the rotor (d-axis in terms of Park transformation).

The distribution of the total magnetomotive force (mmf) produced in the air gap by the three rotor coils carrying identical DC current can be expressed (assuming a sinusoidal distribution of turns) as:

$$mmf = \frac{3}{2} {KI}_{d c} cos θ \qquad Eq . 1$$

K is a machine constant (that depends on the construction), I_{dc} is the DC excitation current, and θ is the angle around the periphery of the stator with respect to center of phase a. When the rotor rotates with angular velocity ωᵣ, this magnetic field can rotate following the position of the rotor. Therefore, the distribution of magnetic field in the air gap becomes:

$$mmf = \frac{3}{2} {KI}_{m} cos ( θ - {ω}_{r} t ) \qquad Eq . 2$$

When the synchronous machine operates in steady state, the excitation is DC as shown in the schematic on the left in FIG. 6. When a large disturbance in the system occurs (in the transient stability sense) it can be advantageous to have control of the magnitude and angle of the mmf independently from the mechanical position of the rotor. With the traditional fixed pole rotor construction of available synchronous generators (both salient pole and round rotors), only the magnitude of the mmf can be controlled, but the field direction is mechanically fixed to the rotor position.

With DC excitation on the three windings, the angle of the mmf can be controlled by changing the direction (or magnitude) of the currents injected in each winding. The schematic on the right of FIG. 6 shows that the current of rotor winding “c” (illustrated with the crosses and dots) has been inverted. The mmf can be at −60° (π/3 rad) with respect to the mechanical axis of the rotor. This is expressed mathematically as:

$$mmf = \frac{3}{2} {KI}_{m} cos ( θ - {ω}_{r} t - π / 3 ) \qquad Eq . 3$$

For AC excitation, if the (wound) rotor of the synchronous generator is excited with a balanced three-phase low-frequency current source, it is possible to track the mechanical speed of the rotor and compensate for the angle. When the rotor is accelerating, the mmf can be shifted in the opposite direction to prevent the power angle to exceed the critical value.

The mmf induced by a wound rotor synchronous generator excited with a three-phase AC current source can rotate at a different speed than the mechanical rotation of the rotor. Supplying positive sequence excitation can yield a super-synchronous mmf while a negative sequence excitation can produce a sub-synchronous mmf. Mathematically, the distribution of the rotating electromagnetic field (or travelling wave) can be expressed as:

$$mmf = \frac{3}{2} {KI}_{m} cos ( θ - ( {ω}_{r} + {ω}_{e} ) t - π / 3 ) \qquad Eq . 4$$

Iₘ is the peak value of the excitation AC current and ωᵣ is the angular frequency of the three-phase rotor excitation current.

During an electromechanical transient, the velocity of the mmf can be controlled to be equal to the synchronous speed of the system (ωₛ). The synchronous speed of the system of the system can be represented by Eq. 5.

ωₛ=ωᵣ+ωₑ Eq. 5

The synchronous speed of the system can be used to determine the frequency of the excitation as:

ωₑ=ωₛ−ωᵣ Eq. 6

Therefore, in theory, the rotation of the “internal” angle of the machine (e.g., the rotor mmf) can be controlled to be in synchronism with the system angle (e.g., the angle of the stator travelling wave).

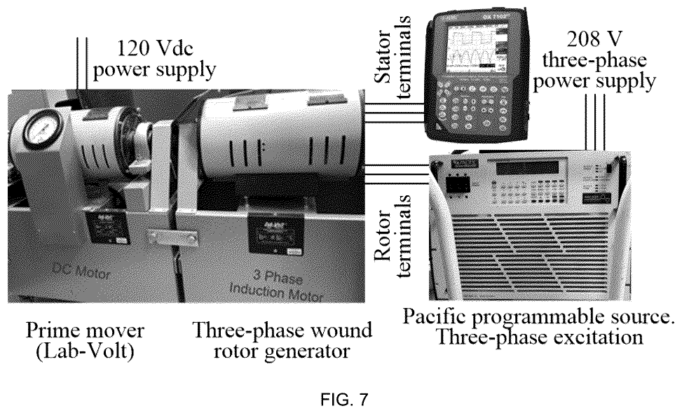

Laboratory experiments can be conducted to corroborate Equation 4. FIG. 7 shows the experimental setup. A four-pole wound rotor induction machine can be mechanically coupled to a DC motor to serve as prime mover. The shaft can be driven at 1800 rpm, which corresponds to 60 Hz. A programmable source can provide three-phase current excitation to the rotor windings of the induction machine.

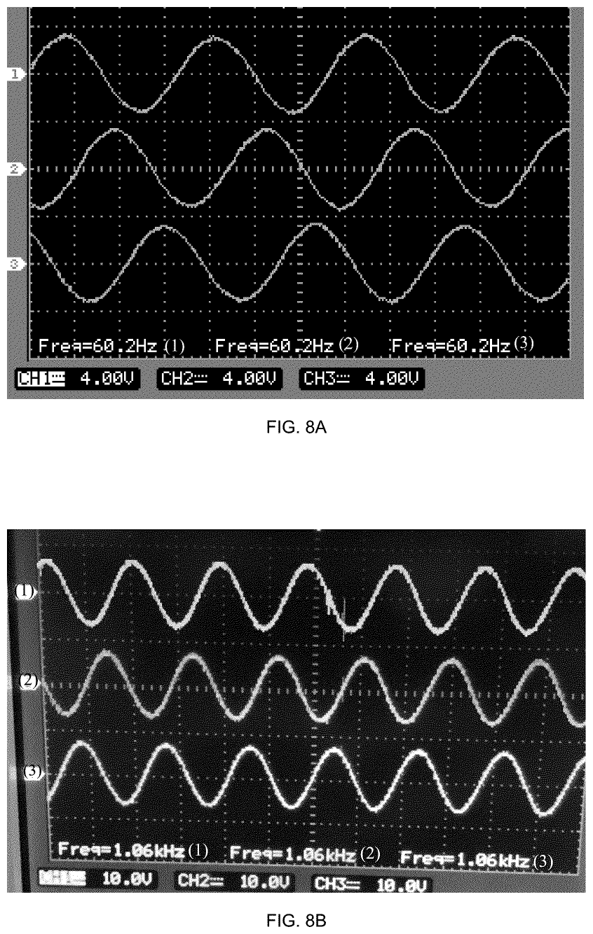

FIGS. 8A and 8B illustrate the voltage captured at the terminals of a three-phase wound rotor machine fed from the rotor windings from the laboratory experiment. FIG. 8A shows a DC excitation in one rotor winding. FIG. 8B shows a three-phase excitation at 1 kHz.

FIG. 8A shows the terminal voltages captured with a three-phase power analyzer when a DC excitation is fed to one of the rotor windings. The induction machine generates a set of three-phase balanced voltages at 60 Hz. FIG. 8B shows the terminal voltages when three-phase voltage at 1 kHz is fed to the rotor windings. The frequency of the machine terminal voltage is now 1.06 kHz. Experiments with excitation frequencies of 400 Hz and 2 kHz also confirm the validity of Equation 4. The experiments confirm that the frequency of the mmf is equal to the sum of the electrical and mechanical frequencies (ω_{mmf}=ωᵣ+ωₑ).

The electromagnetic transients program (EMTP) can be used for simulations because it has an induction (asynchronous) machine model with customizable features and parameters for the rotor, which can enable the implementation of the systems and methods of the present disclosure. These parameters can include the number of rotor poles, the type of rotor, rotor excitation, rotor speed/torque control, and rotor impedance among others. By applying a constant rotation speed to the asynchronous machine model with a specific rotor configuration and adjusting the rotor impedance, a certain amount of power can be generated for a given load with specific voltage characteristics.

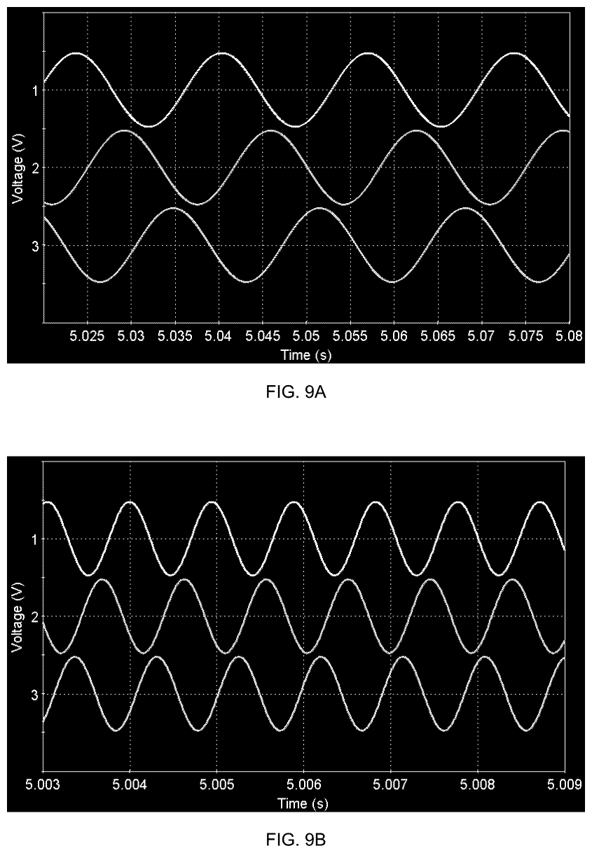

To ensure that the asynchronous machine model in the EMTP behaves exactly like a real wound rotor generator, different rotor configurations can be tested to reproduce the voltage outputs from laboratory experiments. Several rotor configurations can be tested. Here we show the cases of single-phase DC and three-phase 1 kHz excitations. The simulation using the EMTP for each of these rotor excitation models produced exactly the same voltage waveforms as in the laboratory experiment. FIGS. 9A and 9B illustrate simulated terminal voltages of a three-phase wound rotor machine. FIG. 9A shows the terminal voltage with DC current excitation corresponding to FIG. 8A. FIG. 9B shows the case of three-phase excitation at 1 kHz corresponding to FIG. 8B.

The process to adjust the mmf angle can include applying a desired voltage source across the rotor terminals of the wound rotor asynchronous machine. Transient simulations show that the voltage angle in each phase can be increased or decreased as a result of changing the rotor excitation.

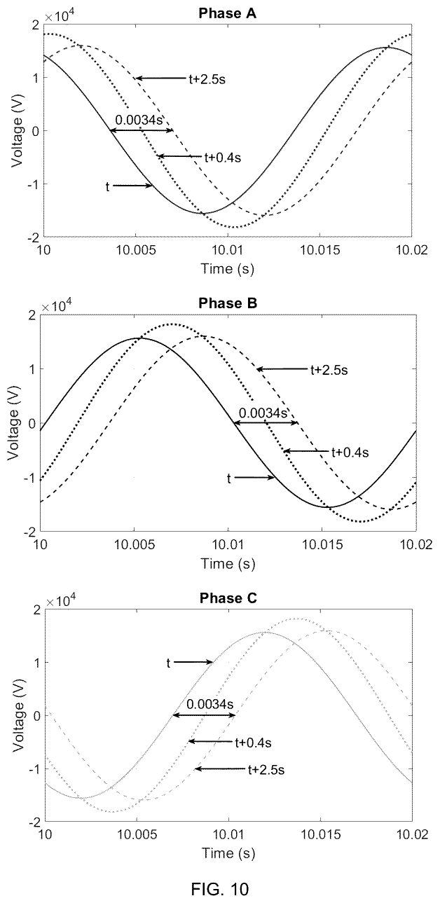

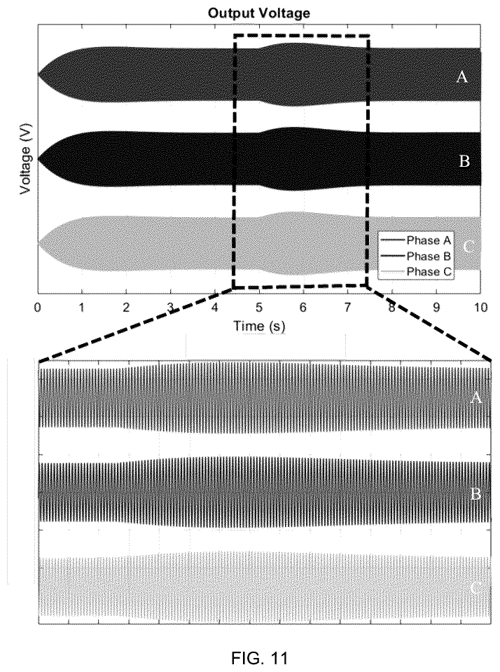

FIG. 10 shows the simulation results for a two-pole asynchronous machine with a three-phase DC excitation. In the simulation, the mmf can begin in phase with the mechanical axis of the rotor. Then, it can be shifted 60° by adjusting the exciter voltages depicted in FIG. 6. FIG. 10 shows the resulting output voltage waveforms at different intervals following the shift and compares them to the steady state case without adjusting excitation. By taking the difference in time between the zero crossings, it can be seen that a −60° shift in the mmf can correspond to the same shift in the output voltages.

A 3.4 ms phase shift at 50 Hz can be equal to 1.068 rad or approximately 60°. This shift can have the effect of temporarily increasing the effective angular velocity of the rotor causing a short voltage (and power) increase before the machine returns to steady state as can be seen in FIG. 11. FIG. 11 illustrates the transient from start up to steady state, to excitation shift, to a new steady state 60° ahead. The opposite can be accomplished by shifting the mmf in the other direction. In this simulation, the rotor mechanical angular velocity can remain constant and the exciter voltage shifts occur instantaneously resulting in a phase change in the output voltages following a short time constant given by the inductance and the winding resistance τ=L/R. A more complex model can be examined below using alternating current exciter voltages in response to a three-phase fault to ground in a power system.

The EMTP asynchronous machine (ASM) model can reproduce the experiments and that the power angle can be adjusted by manipulating rotor excitation settings. Below, a validation using a single machine infinite bus (SMIB) system is provided and validated using PSS/E.

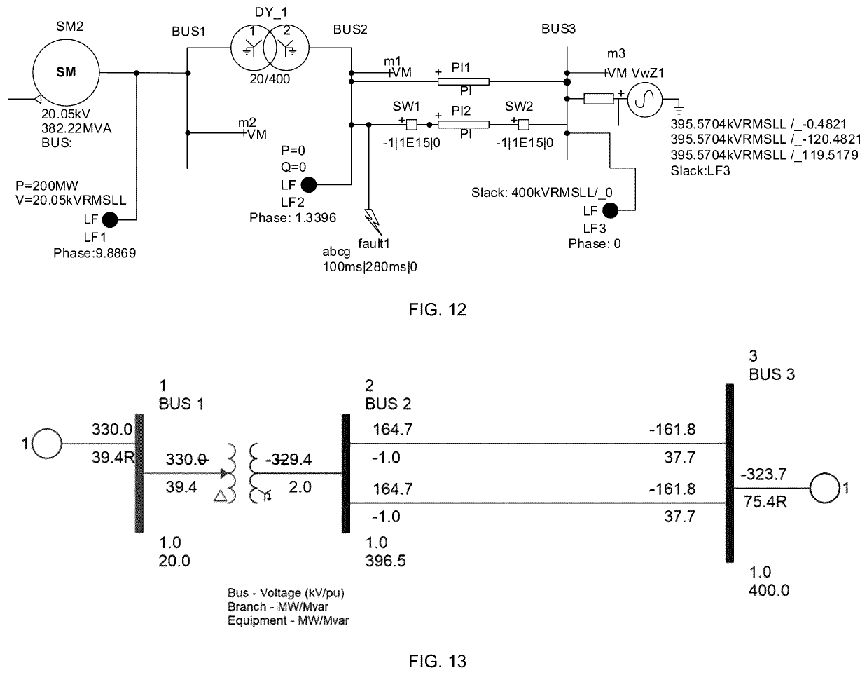

The reliability of results from EMTP simulations can be verified using Siemens PSS/E was done. A standard Single-Machine Infinite-Bus (SMIB) system can be built on both PSS/E and EMTP. FIGS. 12 and 13 show the systems on both pieces of software.

The Critical Clearing Time (CCT) can be found for a fault applied at 0.1 s on both test systems. For the PSS/E system, the critical clearing time can be between 0.175 s and 0.180 s with the system becoming instable at 0.28 s (the fault was applied at 0.1 s). The EMTP system can follow suit with exactly the same results for the CCT. The voltage, power, and rotor angle of the synchronous machine and buses can be compared and found to be within ±1% limits from each other. The reactive power transferred in the EMTP system can be slightly higher, but this could be due to the difference in the reactance of the transmission lines when compared to the PSS/E system. EMTP can be used for transient stability studies.

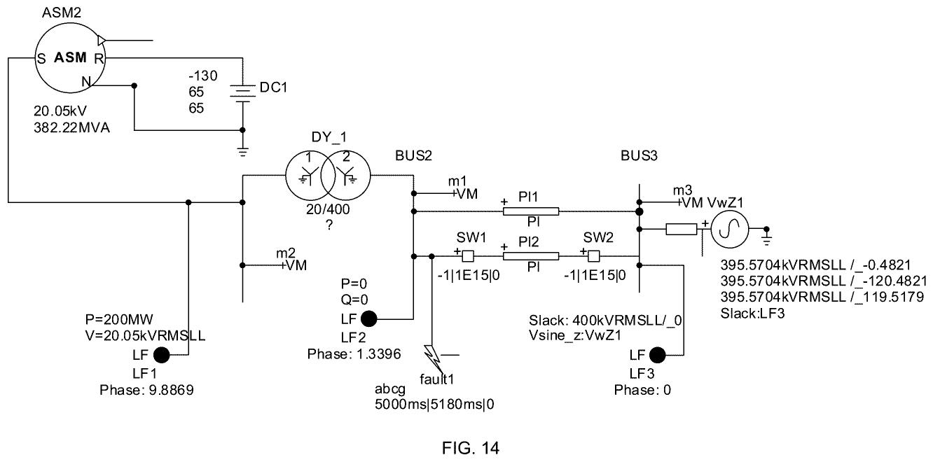

The synchronous machine in the SMIB validation system in FIG. 12 can be replaced by an asynchronous generator with a three-phase DC rotor exciter. The DC exciter can be modeled by connecting a static DC voltage to each phase between the terminals of the rotor. FIG. 14 shows the SMIB system with the asynchronous machine with DC excitation.

To establish that the ASM machine was representative of the synchronous machine response, the three-phase DC rotor ASM can be adjusted to more accurately reflect the results when using the synchronous machine. This can be achieved by manipulating the d- and q-axis mutual inductance to arrive at the same critical clearing time. A transient stability study can be done to prove that the ASM with DC rotor excitation could reproduce a similar critical clearing time as the synchronous machine SMIB model. Table 1 shows the power flow results for the three cases: PPS/E, EMTP using a synchronous generator, and EMTP using an induction generator excited with dc. One can see that the results match very well.

Table 1 shows a comparison between PPS/E & EMTP systems.

| | | | EMTP | EMTP |
|---|---|---|---|---|
| | | PSS/E | SM | ASM |
| SM Bus | Bus 1 (kV)- | 20.05 | 20.05 | 20.05 |
| | Phase A | | | |
| Xfmr HV | Bus 2 (kV)- | 400 | 402.5 | 400 |
| | Phase A | | | |
| Infinite Bus | Bus 3 (kV)- | 400 | 400 | 400 |
| | Phase A | | | |
| Bus 1-2 | P12 (MW) | 200 | 200 | 200 |
| | Q12 (Mvar) | 9.9 | 7.3 | — |
| Bus 2-3 Line 1 | P12 (MW) | 99.9 | 99.8 | 99.9 |
| | Q12 (Mvar) | −2.6 | −11.3 | — |
| Bus 2-3 Line 2 | P12 (MW) | 99.9 | 99.8 | 99.9 |
| | Q12 (Mvar) | −2.6 | −11.3 | — |

| | | | |
|---|---|---|---|
| Machine Power Angle (deg.) | 56.4 | 56.0 | 56.1 |

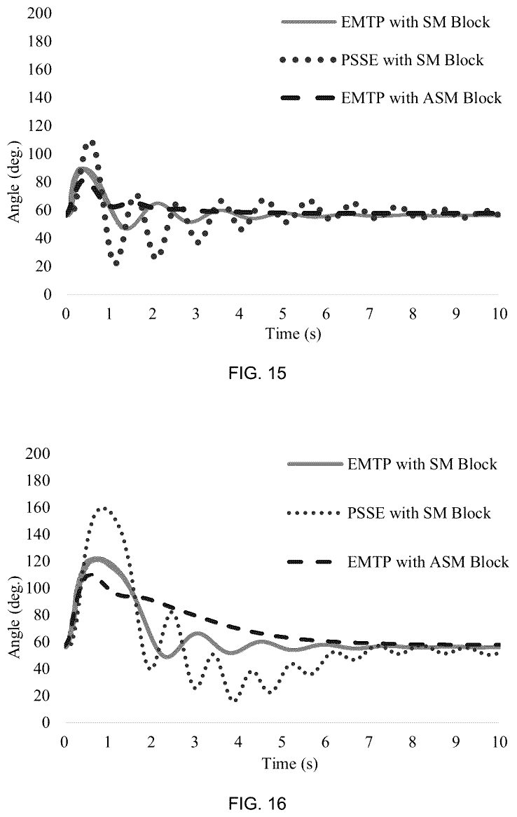

FIG. 15 shows the behavior of the power angle in all systems when a fault is applied at 0.1 seconds and cleared at 0.2 seconds (e.g., before the critical clearing time). FIG. 15 illustrates a fault cleared at 100 ms comparison between EMTP and PSS/E. All systems managed to return to stability. FIG. 13 shows that, as the critical clearing time is neared the systems are on the verge of instability but manage to return to stability. After multiple trials, the critical clearing time of all systems were determined to be 0.180 seconds as seen in FIG. 14. Therefore, since all systems have similar behavior and critical clearing times under similar fault conditions this can show that the ASM block in EMTP can be used reliably to generate similar critical clearing times when compared to a SMIB system. An ASM with variable excitation can be used to double the critical clearing time in an infinite bus model.

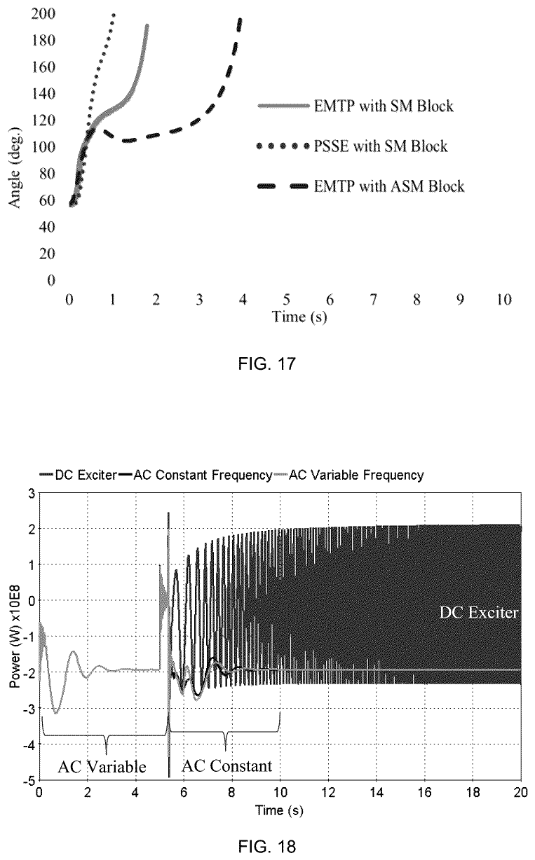

FIG. 16 illustrates a fault cleared at 175 ms comparison between EMTP and PSS/E. FIG. 17 illustrates a fault cleared at 180 ms comparison between EMTP and PSS/E.

The system can be validated through comparison with the industry standard software (PSS/E). The rotor excitation method can be applied to the same SMIB system to demonstrate its effectiveness in response to a three-phase fault to ground.

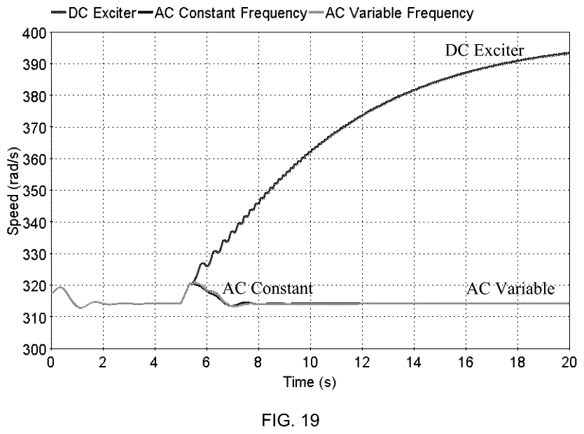

The rotor exciter can be modeled using a series of switches to change from the original rotor DC excitation to an AC excitation at the start of the fault and back to DC after the fault has cleared. This configuration can be applied for an AC exciter with a constant frequency as well as for an AC exciter with a variable frequency based on the difference between the synchronous speed of the machine and its instantaneous mechanical angular velocity as stated in Eq. 6. Results are shown in FIGS. 18 and 19 and compared with that of the DC exciter for a fault duration of 360 ms. FIG. 18 illustrates the output power of standard DC excitation rotor, constant frequency AC excitation rotor, and variable frequency AC excitation rotor. FIG. 19 illustrates the mechanical angular velocity of standard DC excitation rotor, constant frequency AC excitation rotor, and variable frequency AC excitation rotor.

The standard DC excitation cannot withstand a clearing time beyond its critical clearing time of less than 180 ms while the shifting mmf from the AC excitation allows the generator to return to stability after a fault duration that is double the original.

Factors for nominal operation of the exciter method can include AC exciter frequency, timing of the switches, and final position of the mmf. All other system variables can remain the same as the simulations of the ASM used for validation including ASM settings and SMIB system parameters.

Table 2 shows the settings for the AC exciter simulations.

| | AC Constant Frequency | AC Variable Frequency |
|---|---|---|
| Starting mmf Position | −180° | −180° |
| Start of Fault | 5 s | 5 s |
| Switch to AC Exciter | 5 s | 5 s |
| AC Frequency | 0.8 Hz | ~1 Hz* |
| End of Fault | 5.36 s | 5.36 s |
| Switch back to DC | 5.6 s | 6 s |
| Final mmf Position | −180° | −180° |

While the constant frequency rotor can maintain a 0.8 Hz signal, the variable frequency rotor can gradually reach a maximum of 1 Hz and then slows once the machine recovers. The conditions for recovery can allow for a small margin in the settings to reach stability.

The simulation results show that the critical clearing time of a generator can be doubled by shifting the mmf opposing the increase in rotational speed caused by the acceleration of the rotor during a fault. This method could be applied to a fault of indefinite duration.

The rotor angle stability performance of power systems can be greatly enhanced using wound rotor synchronous generators. Three-phase wound rotor machines can be operated as synchronous generators. Then the field can be excited with a low frequency AC excitation (e.g., a few Hertz). As the rotor of a generator accelerates (because of a fault), the windings can be excited to produce an mmf that moves in the opposite direction. This control technique can effectively compensate for the changes of the mechanical speed to produce an mmf that remains constant at the pre-fault power angle. A model for the new machine can be built in the EMTP using the built-in model of a wound rotor motor as the basis. The EMTP stability model can be validated against simulations using PSS/E. Transients stability studies using the EMTP can show that the critical clearing time can be doubled. Various operating strategies to improve the transient stability of generators can be presented.

The synchronous generator (e.g., power generator, AC power generator) can include a rotor. The synchronous generator can include a three-phase low frequency alternating current source in communication with the rotor. The rotor can include a wound rotor with three-phase windings. The synchronous generator can include a DC motor coupled with the rotor. The three-phase low frequency alternating current source can have a frequency in a range of 1 Hz to 50 Hz. Low frequency can include a frequency less than or equal to 50 Hz.

In some embodiments, an angle of an induced magnetomotive force is controlled independently from a mechanical angle of the rotor during a transient. A magnetomotive force can be produced that remains constant at a pre-fault angle.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should al so be noted that the words “component” and “module,” as used herein and in the claims, are intended to encompass implementations using one or more lines of software code, and/or hardware implementations, and/or equipment for receiving manual inputs.

As used herein, the singular forms “a”, “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed:

1. A synchronous generator comprising:
a stator;
a rotor in communication with the stator; and
a three-phase high frequency alternating current source in communication with the rotor.

2. The synchronous generator of claim 1, wherein the rotor comprises silicon-steel alloy.

3. The synchronous generator of claim 1, wherein the three-phase high frequency alternating current source has a frequency in a range of greater than 50 Hz to 6 kHz.

4. The synchronous generator of claim 1, wherein the three-phase high frequency alternating current source has a frequency in a range of greater than 50 Hz to 500 Hz.

5. The synchronous generator of claim 1, wherein the rotor is a wound rotor with equidistant three-phase windings.

6. A synchronous generator comprising:
a rotor;
a three-phase high frequency alternating current source in communication with the rotor;
an input line in electrical communication with the three-phase high frequency alternating current source; and
a stator in communication with the rotor and an output line in communication with an electrical system, the output line being in electrical communication with the input line.

7. The synchronous generator of claim 6, wherein the three-phase high frequency alternating current source has a frequency in a range of greater than 50 Hz to 6 kHz.

8. The synchronous generator of claim 6, wherein the three-phase high frequency alternating current source has a frequency in a range of greater than 50 Hz to 500 Hz.

9. The synchronous generator of claim 6, wherein the rotor is a wound rotor with equidistant three-phase windings.

10. The synchronous generator of claim 6, further comprising at least one AC-to-DC link and one DC-to-AC link.

11. The synchronous generator of claim 6 wherein the output line further comprises an AC-to-DC link in communication with a high voltage DC line connected to a DC-to-AC link.

12. The synchronous generator of claim 6, wherein the input line includes an AC-to-DC link and a DC to a greater than 50 Hz to 6 kHz AC link in communication with the three-phase high frequency alternating current source.

13. The synchronous generator of claim 12 wherein the output line further comprises a greater than 50 Hz to 6 kHz AC link to DC link and an DC to a 60 Hz AC link.

14. The synchronous generator of claim 12, further comprising an AC-to-DC link in communication with a high voltage DC line connected to a DC to AC link.

15. A synchronous generator comprising:
a rotor; and
a three-phase low frequency alternating current source in communication with the rotor.

16. The synchronous generator of claim 15, wherein the rotor is a wound rotor with three-phase windings.

17. The synchronous generator of claim 15, wherein the three-phase low frequency alternating current source has a frequency in a range of 1 Hz to 50 Hz.

18. The synchronous generator of claim 15, wherein an angle of an induced magnetomotive force is controlled independently from a mechanical angle of the rotor during a transient.

19. The synchronous generator of claim 15, wherein a magnetomotive force is produced that remains constant at a pre-fault angle.

20. The synchronous generator of claim 15, further comprising a DC motor coupled with the rotor.
